(19) United States
(12) Patent Application Publication
(10) Pub. No.: US 2024/0203285 A1
(43) Pub. Date: Jun. 20, 2024

(54) Extended Reality-Based Training for Cellular Site Field Technicians

(71) Applicant: T-Mobile USA, Inc., Bellevue, WA (US)

(72) Inventor: Joseph Lee, Atlanta, GA (US)

(21) Appl. No.: 18/066,173

(22) Filed: Dec. 14, 2022

(51) Int. Cl. G09B 19/00; G02B 27/01; G06F 3/01; G06N 20/00

(52) U.S. Cl. CPC G09B 19/003; G02B 27/017; G06F 3/011; G06N 20/00

(57) ABSTRACT

Described herein are methods and devices associated with extended reality (XR) headsets for participating in training offered through cellular site field technician training modules. Also described herein are servers and methods for identifying and providing those modules. Based on at least one of a location, an environment type, a cellular site technology, or a minimum level or requirements, a subset of cellular site field technician training modules are identified. A trainee then uses the XR headset to participate in training offered through those cellular site field technician training modules, and a result is reported to the servers.

### BACKGROUND

Cellular site field technicians deal with many environmental and technical hurdles while visiting and servicing cellular sites. Aggressive animals, inclement weather, remote and difficult to access cellular sites: these, along with constantly changing cellular technologies, are just a few of the challenges field technicians deal with. Effective training must cover so many issues that it is difficult to have it often enough and at enough locations. Some of these training aspects can be addressed with computer-based training, but many require real-world experience.

Extended reality (XR), including augmented reality (AR) and virtual reality (VR) can be experienced by users through XR headsets. These XR headsets provide access to entire virtual worlds and to games within those worlds.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows example user interfaces of a trainee device used by a trainee to participate in training offered through cellular site field technician training modules.

FIG. 2 shows an example of a network environment with trainee devices connected to a server for cellular site field technician training. The server identifies subsets of cellular site field technician training modules for the trainee devices, and the trainee devices enable participation in training offered through those modules. Other developer systems and telecommunication network systems may communicate with the server.

FIG. 3 shows an example of a system architecture for a computing device associated with an XR headset.

FIG. 4 shows an example of a system architecture for a server associated with cellular site field technician training.

FIG. 5 shows a flowchart of an example method by which a trainee device receives identification of a subset of cellular site field technician training modules, enables trainee participation in training offered through those modules, and reports a result of the participation.

FIG. 6 shows a flowchart of an example method by which a server associated with cellular site field technician training receives requests to identify subsets of those modules and answers those requests.

### DETAILED DESCRIPTION

Described herein are methods and devices associated with XR headsets for training of cellular site field technician trainees offered through cellular site field technician training modules. These cellular site field technician training modules (also referred to herein as “training modules” and “modules”) may be experienced by trainees wearing XR headsets as games or other educational challenges. Also described herein are servers and methods for identifying and providing these training modules. Based on at least one of a location, an environment type, a cellular site technology, a minimum level or requirements, etc. a training server identifies a subset of cellular site field technician training modules. A trainee then uses the XR headset to participate in training offered through those training modules, and a result is reported to the training servers.

Training that covers the issues a cellular site field technician (also referred to herein as a “field technician”) is likely to encounter can involve many different scenarios and technologies and can vary quite a bit from place to place. Training for a field technician working in a desert environment may vary quite a bit from training in a rainy, wooded, or mountainous environment. Both extreme heat and extreme cold, for example, can lead to different safety precautions for the field technician and different maintenance issues for cellular site equipment. Field technicians may also encounter dangerous animals, belligerent neighbors, challenging landscapes that could lead to injury or lack of access to a cellular site needing maintenance. Likewise, new technologies such as updates required to support new generations of telecommunication networks, can require additional training.

To allow for flexibility in the time, place and manner of such training and to allow it to be customized to the circumstances of a trainee, XR experiences (e.g., VR games) can be helpful. A training server, learning information about a trainee, such as where the trainee will work, what the trainee's work and educational backgrounds are, and what training the trainee has had before, can select a subset of available training modules that best fits the information about the trainee. A trainee who is to work mostly in higher altitudes, for example, might not be presented with a training module about the hurdles posed by cactuses near a cellular tower and how to treat a cactus injury.

After training is completed, the trainee's device (XR headset or a connected computing device) reports a result to the training server. The result can lead to selection of additional training modules for the trainee to complete, certification that requirements are met, availability to receive job assignments, etc. In some implementations, the trainee may also be required to complete real-world tasks or computer-based training in addition to the training offered through the training modules. Further, the trainee's device and training server may participate in machine learning to improve identification of training modules for trainees.

### Overview

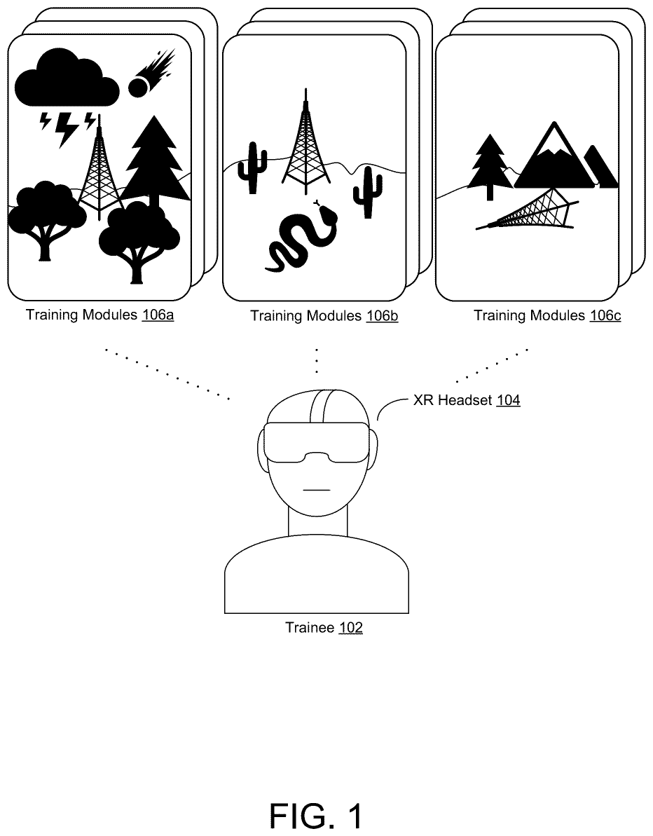

FIG. 1 shows example user interfaces of a trainee device used by a trainee to participate in training offered through cellular site field technician training modules. As illustrated, a trainee 102 wearing an XR headset 104 may participate in training offered through cellular site field technician training modules, such as modules 106a, modules 106b, or modules 106c. Modules 106a may be cellular site field technician training modules associated with a particular environment (e.g., forested environment). Modules 106b may be cellular site field technician training modules associated with a particular hazard (e.g., wild animals). Modules 106c may be cellular site field technician training modules associated with a particular technical challenge (e.g., new radio access technology upgrade or damage to a cellular tower).

Completion of training offered through the modules 106 causes a result to be reported. In some implementations, after completion of training with modules 106 but prior to reporting results, the trainee 102 may be required to complete a real-world task or other computer-based training or may be required to complete additional cellular site field technician training modules.

In various implementations, the XR headset 104 may be any sort of computing device providing an immersive, visual experience. Such devices include VR goggles/glasses worn over a user's eyes and providing a three-dimensional display that convinces the user that he or she is in the video being displayed. With such XR headsets 104, users can experience games, videos, and entire worlds, any or all of which may be interactive. Such interactivity may rely on additional peripherals, such as remote controls held by user hands, gloves worn on user hands, etc.

The trainee 102 may be any person working or desiring to work as a cellular site field technician. To experience training, the trainee 102 wears the XR headset 104, which may have a training application installed or be paired to a computing device having a training application. Based on information about the trainee 102, obtained from the trainee 102 or through integration with computer systems of a trainee's employer, the training application obtains training modules from a training server that are particularized for the trainee 102. For example, the location where the trainee is to work, a list of previous training, past job experiences, education, or certifications can all be provided and used by the training server to identify appropriate training modules. The training server then provides these modules, which are used by the training application, along with the XR headset 104, to provide training to the trainee 102.

Training Modules 106 include various subsets of training modules. Training modules 106a are shown, in FIG. 1, to include a cellular site in a specific environment— a forested area— with implement weather (a thunderstorm) and a possible natural disaster (a meteorite). A trainee 102 using the XR headset 104 for training module 106a may experience the scene shown in FIG. 1 for module 106a as if the trainee 102 is actually there. The trainee 102 may be expected to perform certain tasks or act in certain ways to successfully complete the training.

Training modules 106b are shown in FIG. 1 to include a cellular site in a desert with a poisonous animal— a snake. A trainee 102 using the XR headset 104 for training module 106b may be required to, for example, treat a snakebite or avoid the snake and repair damage to base station equipment typical of a desert environment (e.g., damage caused by extreme heat and sand/dust).

Training modules 106c are shown in FIG. 1 to include a cellular site with damage to a cellular tower. A trainee 102 using the XR headset 104 for training module 106c may be required to repair the damage to the cellular tower.

The trainee 102 may be required to complete any or all of the training modules 106a-106c or other, additional training modules 106 besides those. Training modules 106a-106c are given here simply as examples. Upon completing required training or a part of it, the training application may report a result to the training server, which may certify, in conjunction with trainee employer systems, completion of the required training. The training modules 106 for the required training may be a base set of training modules 106 associated with job requirements or a safety certification.

In some implementations, until the user has completed the required training, job tasks may be locked or not shown to the trainee 102. Also, new training may be rolled out and added to a trainee's job requirements, with new training modules 106 associated with that training. The trainee 102 may be alerted of the new training and complete the new training modules 106 in order to be certified as meeting requirements.

Job requirements for a trainee 102 may also include real-world tasks or computer-based training— perhaps training that is more difficult to create an XR experience for or training that is very simple and for which such XR training would not be cost-effective. In such cases, completion of training may require both completion of required training modules 106 and completion of the additional tasks and training, and the training server may integrate with other systems to determine if it is complete. If it is, the training server may provide an indication to the trainee 102, though, e.g., the XR headset 104 or an associated computing device that the training is complete. If not complete, the training server can inform the trainee 102 through, e.g., the XR headset 104 or associated computing device that it is not complete and can list the real-world tasks or computer-based training still needed for completion. In some implementations, ones of the training modules 106 may not be available to the trainee 102 until a real-world task or computer-based training is completed.

In various implementations, the training application may allow the trainee 102 to choose additional training and may retrieve the training modules 106 for that additional training from the training server. The additional training may allow the trainee 102 to qualify for additional job tasks or apply for new jobs or roles.

### Example Network Environment

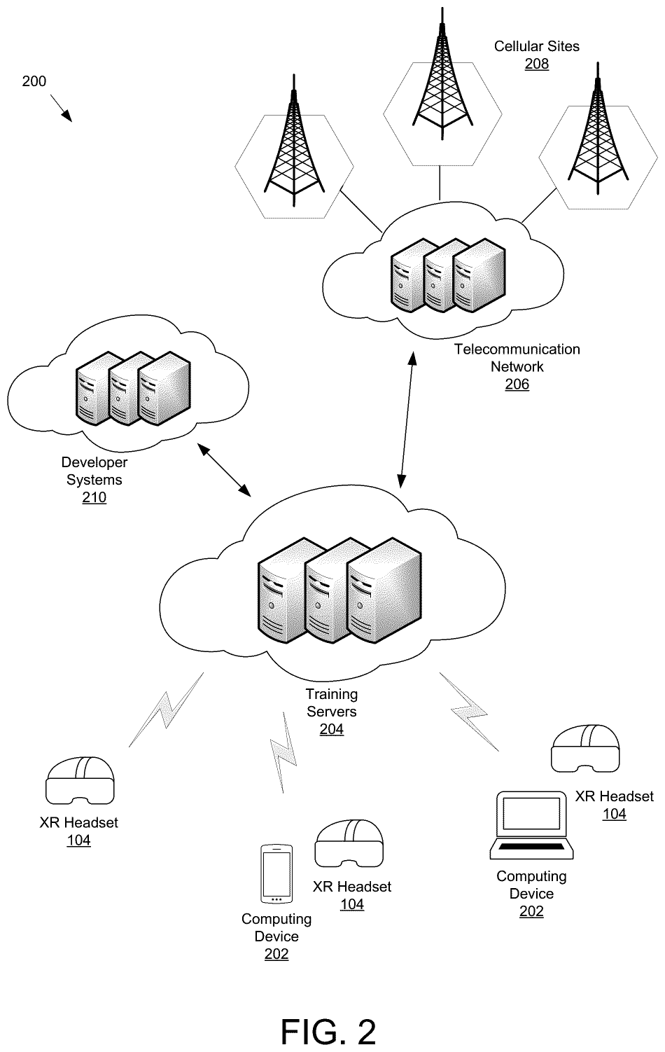

FIG. 2 shows an example of a network environment 200 with trainee devices connected to a server for cellular site field technician training. The server identifies subsets of cellular site field technician training modules for the trainee devices, and the trainee devices enable participation in training offered through those modules. Other developer systems and telecommunication network systems may communicate with the server. As illustrated, a computing device 202 associated with or comprising an XR headset 104 is connected to a server 204 associated with cellular site field technician training. The server 204 may be connected to multiple such computing devices 202 or XR headsets 104. The server 204 may also be connected to (or be part of) a telecommunication network 206 that includes multiple cellular sites 208. Further, the server 204 may be open to connection from developer systems 210 that update or create cellular site field technician training modules and provide those to the server 204.

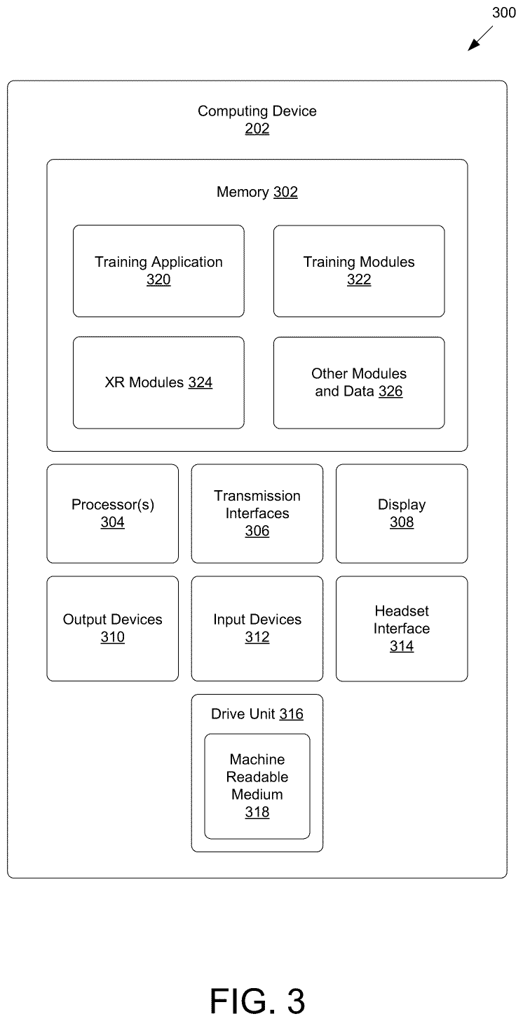

An example XR headset 104 is described herein in additional detail. The computing device 202 may be an example of the XR headset 104 or may be another computing device that is connected to the XR headset 104 using, e.g. wireless or wired mechanisms. Examples of such computing devices 202 include UEs, other cellular devices, mobile devices, Internet-of-Things (IOT) devices, other XR/AR/VR devices, wearable devices, laptops, desktops, media players, gaming devices, or any other sort of computing device of any form factor. Further, the computing device may be configured to communicate with the training server 204 through a communication network. Such a communication network may be a telecommunication network (such as telecommunication network 206), an Internet, a private network, or some combination or sub-combination of these. The computing device 202 may communicate with the communication network through wired or wireless mechanisms. Further, the computing device 202 may support any sort of radio access type, such as fifth generation (5G)/new radio (NR), fourth generation (4G)/Long Term Evolution (LTE) and may also support Wi-Fi communication. An example system architecture of a computing device 202 is shown in FIG. 3 and described below in detail with reference to that figure.

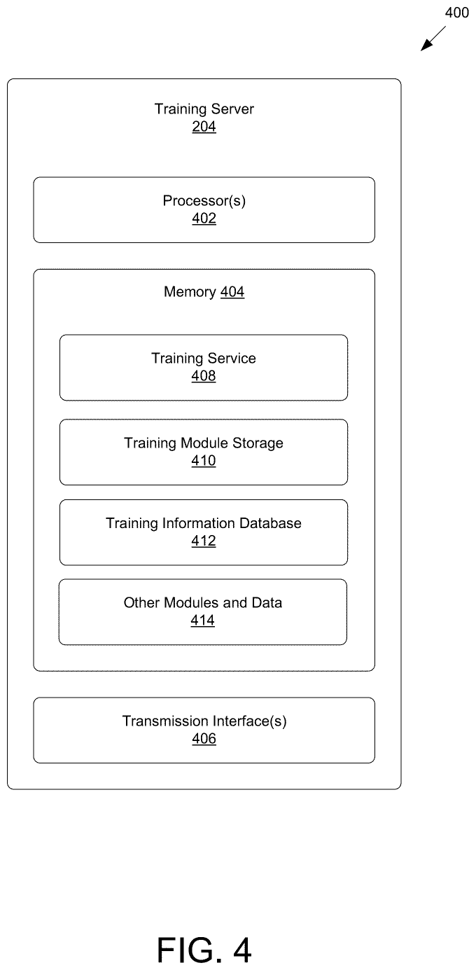

In some implementations, the training server 204 may comprise a storage cloud service with multiple devices implementing a training service, storing training modules 106, and storing other information. Such devices may be any of servers, mainframes, hard drives, or other computing devices and may form part of, e.g., a server farm or other mass storage environment. An example system architecture of a training server 204 is shown in FIG. 4 and described below in detail with reference to that figure.

The training server 204 may be connected to a telecommunication network 206 or be part of such a telecommunication network 206. An operator of the telecommunication network may employ the trainee 102, own or lease the locations of the cellular sites 208, and own or lease the equipment at the cellular sites 208. As noted above, the computing device 202 may connect to the training server 204 through the telecommunication network 206 or independently of it. The telecommunication network 206 may comprise at lease a core network and access networks associated with the cellular sites 208. In some implementations, characteristics of the cellular sites 208 (e.g., location, technologies, etc.) may be associated with at least some of the training modules 106 stored by the training server 204.

In various implementations, the computing device 202 may include a training application, training modules 106 received from the training server 204, and XR modules that provide a platform or services for the XR headset 104 or an interface for connecting to and communicating with the XR headset 104. The training application may perform any or all of the functionality described herein for the computing device XR headset.

The training server 204 may include storage for training modules 106, including multiple different subsets of training modules 106, a training service, and a training information database. The training service references the training information database to identify mappings between locations, skills, qualifications, requirements, etc. and training modules 106. These mappings may be received from an employer of the trainee 102 and other cellular site field technicians or created by the training server 204 based on matches between, e.g., tags associated with training modules 106 and criteria. For example, the criterion “rural Arizona” may be tagged with “extreme heat” and “rattlesnakes”, and a training module 106 provided by developer systems 210 may have similar tags. Based on that, the training server 204 may create a mapping for rural Arizona and that training module and store the mapping in the training information database.

In addition to mappings, the training information database can include training requirements for categories of trainees 102 and specification of which training modules 106 are available to which trainees 102. The training server may update the training information database through integration with the telecommunication network 206 or a system of its operator and may also use that linkage for reporting, managing access to jobs or tasks, etc.

In various implementations, developer systems 210 may create new or updated training modules 106 and provide these to the training server 204. The training server 204 may store these and update the training information database, and the training service may automatically notify trainees 102 to whom the new training modules 106 are applicable.

Machine learning can also be implemented at the computing devices 202 and the training server 204 and utilized to update the mappings in the training information database and inform the operator of the telecommunication network 206 or developer systems 210 of any problems or difficulties users are having with a particular training module.

### Example Architectures

FIG. 3 shows an example of a system architecture 300 for a computing device 202 associated with an XR headset 104. In other implementations, the computing device 202 may be an XR headset and some or all of the hardware and software of the system architecture 300 may be part of the XR headset 104. As shown in FIG. 3, the computing device 202 can have at least one memory 302, processor(s) 304, one or more transmission interfaces 306, a display 308, output devices 310, input devices 312, an XR headset interface 314 and/or a drive unit 316 including a machine readable medium 318.

In various examples, the memory 302 can include system memory, which may be volatile (such as RAM), non-volatile (such as ROM, flash memory, etc.) or some combination of the two. The memory 302 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information and which can be accessed by the computing device 202. Any such non-transitory computer-readable media may be part of the computing device 202.

The memory 302 can include one or more software or firmware elements, such as computer-readable instructions that are executable by the one or more processors 304. For example, the memory 302 can store computer-executable instructions associated with a training application 320, training modules 322, and XR modules 324. These components and data 320-324 are all described further herein in detail. The memory 302 can also store other modules and data 326, which can be utilized by the computing device 202 to perform or enable performing any action taken by the computing device 202. The other modules and data 326 can include a platform, operating system, and applications, and data utilized by the platform, operating system, and applications.

In various examples, the processor(s) 304 can be a CPU, a graphics processing unit (GPU), or both CPU and GPU, or any other type of processing unit. Each of the one or more processor(s) 304 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 304 may also be responsible for executing all computer applications stored in the memory 302, which can be associated with types of volatile (RAM) and/or nonvolatile (ROM) memory.

The transmission interfaces 306 can include transceivers, modems, interfaces, antennas, and/or other components that perform or assist in exchanging RF communications with base stations, a Wi-Fi access point, or otherwise implement connections with one or more networks. The transmission interfaces 306 can also include components for wired communications, such as an Ethernet port.

The display 308 can be a liquid crystal display or any other type of display commonly used in UEs. For example, the display 308 may be a touch-sensitive display screen and can thus also act as an input device or keypad, such as for providing a soft-key keyboard, navigation buttons, or any other type of input.

The output devices 310 can include any sort of output devices known in the art, such as the display 308, speakers, a vibrating mechanism, and/or a tactile feedback mechanism. Output devices 310 can also include ports for one or more peripheral devices, such as headphones, peripheral speakers, and/or a peripheral display.

The input devices 312 can include any sort of input devices known in the art. For example, input devices 312 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism. Further, input devices 312 include at least a camera for capturing images. Such a camera may include any sort or image capturing component.

The XR headset interface 314 may be an example of an interface to, e.g., an XR headset 104, and the computing device 202 may include the XR headset interface 314 when the computing device 202 is not an XR headset but, rather, is connected to one. When the computing device 202 is an XR headset 104, the XR headset interface 314 would not be included as a component of the computing device 202.

The machine readable medium 318 can store one or more sets of instructions, such as software or firmware, that embodies any one or more of the methodologies or functions described herein. The instructions can also reside, completely or at least partially, within the memory 302, processor(s) 304, and/or transmission interface(s) 306 during execution thereof by the computing device 202.

FIG. 4 shows an example of a system architecture 400 for a server 204 associated with cellular site field technician training. As shown, the server 204 can include memory 402, processor(s) 404, and transmission interfaces 406.

In various examples, the memory 402 can include system memory, which may be volatile (such as RAM), non-volatile (such as ROM, flash memory, etc.) or some combination of the two. The memory 402 can also include additional data storage devices (removable and/or non-removable) such as, for example, magnetic disks, optical disks, or tape. Memory 402 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, DVD, or other optical storage, magnetic cassettes, magnetic tape, magnetic disk storage or other magnetic storage devices, or any other non-transitory medium which can be used to store the desired information and which can be accessed by the server 204. Any such non-transitory computer-readable media may be part of the server 204.

The memory 402 can store computer-readable instructions and/or other data associated with operations of the server 204. For example, the memory 402 can store a training service 408. Memory 402 may also include training modules 410 and training information database 412. The modules and data 408-412 are described further herein in greater detail. The other modules and data 414 can be utilized by the server 204 to perform or enable performing any action taken by the server 204. The other modules and data 414 can include a platform, operating system, firmware, and/or applications, and data utilized by the platform, operating system, firmware, and/or applications.

The processor(s) 404 may be a CPU or any other type of processing unit. Each of the one or more processor(s) 404 may have numerous ALUs that perform arithmetic and logical operations, as well as one or more CUs that extract instructions and stored content from processor cache memory, and then executes these instructions by calling on the ALUs, as necessary, during program execution. The processor(s) 404 may also be responsible for executing all computer-executable instructions and/or computer applications stored in the memory 402.

The transmission interfaces 406 can include any wired or wireless equipment connecting to computing devices 202, such as over a wide area network (WAN) (e.g., the Internet), over a telecommunication network, or over some combination thereof. The composition of the transmission interfaces 406 may vary based on which device or devices they are incorporated into and what other functions those devices have. For example, if located in a cloud storage service, transmission interfaces 406 may be mostly or entirely wired interfaces (e.g., Ethernet interfaces).

### Example Operations

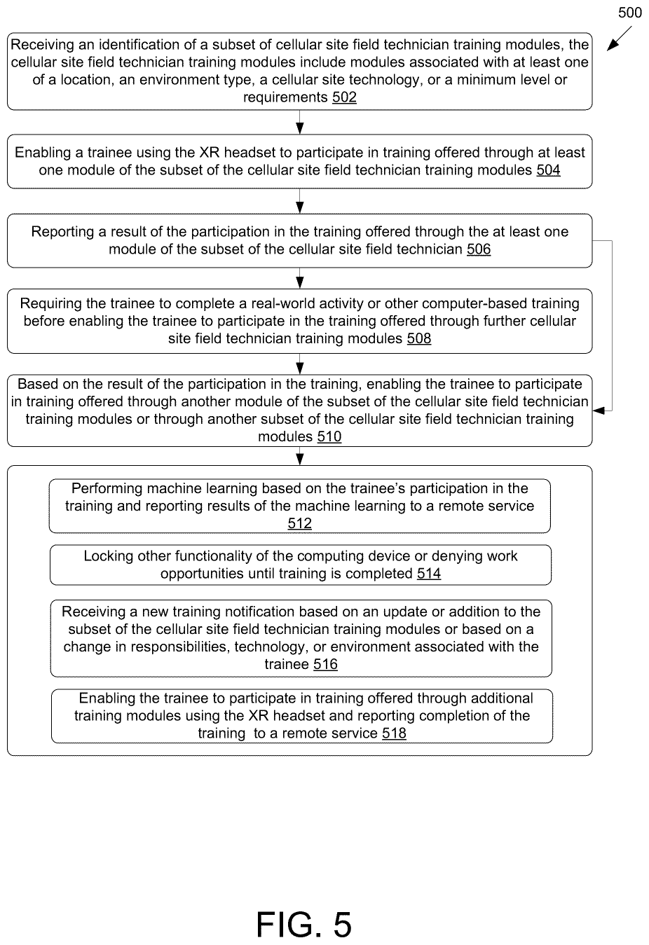

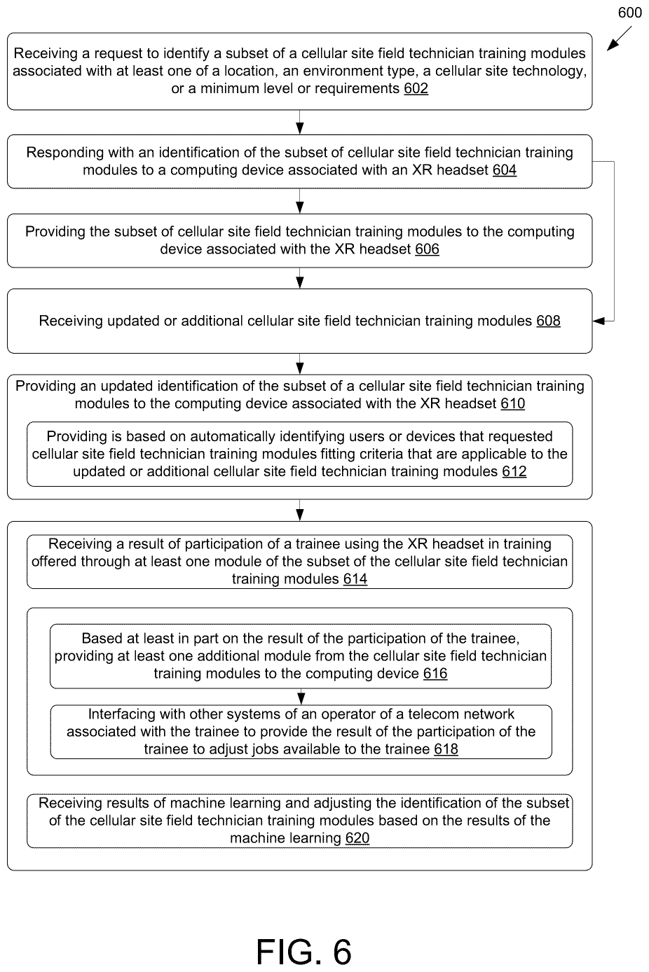

FIGS. 5 and 6 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 5 shows a flowchart of an example method by which a trainee device receives identification of a subset of cellular site field technician training modules, enables trainee participation in training offered through those modules, and reports a result of the participation. As illustrated in FIG. 5 at 502, a computing device at least including or associated with an XR headset receives an identification of a subset of cellular site field technician training modules. The cellular site field technician training modules include modules associated with at least one of a location, an environment type, a cellular site technology, or a minimum level or requirements. In some implementations, the subset comprises a base set of cellular site field technician training modules associated with job requirements or a safety certification.

At 504, the computing device enables a trainee using the XR headset to participate in training offered through at least one module of the subset of the cellular site field technician training modules.

At 506, the computing device reports a result of the participation in the training offered through the at least one module of the subset of the cellular site field technician training modules. The result may be a certification that required training has been completed. Further, the certification may be based on the result alone or based on a combination of two or more of the result, real-world training completion, or other computer-based training completion.

At 508, the computing device may require the trainee to complete a real-world activity or other computer-based training before enabling the trainee to participate in the training offered through another module of the subset of the cellular site field technician training modules or through another subset of the cellular site field technician training modules.

Following 506 or 508, at 510, and based on the result of the participation in the training offered through the at least one module of the subset of the cellular site field technician training modules, the computing device enables the trainee to participate in training offered through another module of the subset of the cellular site field technician training modules or through another subset of the cellular site field technician training modules.

Following 510, the computing device may perform any, none, or all of operations 512-518 in any order.

At 512, the computing device may perform machine learning based on the trainee's participation in the training offered through the at least one module of the subset of the cellular site field technician training modules. Also, the computing device may report results of the machine learning to a remote service associated with the cellular site field technician training modules.

At 514, the computing device may lock other functionality of the computing device or deny work opportunities until training is completed.

At 516, the computing device may receive a new training notification based on an update or addition to the subset of the cellular site field technician training modules or based on a change in responsibilities, technology, or environment associated with the trainee.

At 518, the computing device may enable the trainee to participate in training offered through additional training modules using the XR headset and report completion of the training offered through the additional training modules to a remote service.

FIG. 6 shows a flowchart of an example method by which a server associated with cellular site field technician training modules receives requests to identify subsets of those modules and answers those requests. As illustrated in FIG. 6 at 602, a computing device receives a request to identify a subset of a cellular site field technician training modules associated with at least one of a location, an environment type, a cellular site technology, or a minimum level or requirements. The computing device may be a server associated with cellular site field technician training.

At 604, the computing device responds with an identification of the subset of cellular site field technician training modules to a computing device associated with an XR headset.

At 606, the computing device may provide the subset of cellular site field technician training modules to the computing device associated with the XR headset.

At 608, following 604 or 606, the computing device receives updated or additional cellular site field technician training modules.

At 610, the computing device provides an updated identification of the subset of a cellular site field technician training modules to the computing device associated with the XR headset. The updated identification includes identification of the updated or additional cellular site field technician training modules. In some implementations, at 612, the providing is based on automatically identifying users or devices that requested cellular site field technician training modules fitting criteria that are applicable to the updated or additional cellular site field technician training modules.

Following 610, the computing device may perform either, both, or neither of 614 and 620.

At 614, the computing device may receive, from the computing device associated with the XR headset, a result of participation of a trainee using the XR headset in training offered through at least one module of the subset of the cellular site field technician training modules.

Following 614, the computing device may perform either, both, or neither of 616 and 618.

At 616, based at least in part on the result of the participation of the trainee, the computing device may provide at least one additional module from the cellular site field technician training modules to the computing device. Further, in some implementations, providing the at least one additional module from the cellular site field technician training modules may be based on other results from real-world activities or other computer-based training.

At 618, the computing device may interface with other systems of an operator of a telecommunication network associated with the trainee to provide the result of the participation of the trainee to adjust jobs available to the trainee.

At 620, the computing device may receive results of machine learning from the computing device and from other computing devices and adjust the identification of the subset of the cellular site field technician training modules based on the results of the machine learning.

### CONCLUSION

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method comprising:
receiving, by a computing device at least including or associated with an extended reality (XR) headset, an identification of a subset of cellular site field technician training modules, the cellular site field technician training modules including modules associated with at least one of a location, an environment type, a cellular site technology, or a minimum level or requirements;
enabling, by the computing device, a trainee using the XR headset to participate in training offered through at least one module of the subset of the cellular site field technician training modules;
reporting, by the computing device, a result of the participation in the training offered through the at least one module of the subset of the cellular site field technician training modules; and
enabling, by the computing device, the trainee to participate in training offered through another module of the subset of the cellular site field technician training modules or through another subset of the cellular site field technician training modules based on the result of the participation in the training offered through the at least one module of the subset of the cellular site field technician training modules.

2. The computer-implemented method of claim 1, wherein the subset comprises a base set of cellular site field technician training modules associated with job requirements or a safety certification.

3. The computer-implemented method of claim 1, wherein the result is a certification that required training has been completed.

4. The computer-implemented method of claim 3, wherein the certification is based on the result alone or based on a combination of two or more of the result, real-world training completion, or other computer-based training completion.

5. The computer-implemented method of claim 1, further comprising performing machine learning based on the trainee's participation in the training offered through the at least one module of the subset of the cellular site field technician training modules and reporting results of the machine learning to a remote service associated with the cellular site field technician training modules.

6. The computer-implemented method of claim 1, further comprising requiring the trainee to complete a real-world activity or other computer-based training before enabling the trainee to participate in the training offered through the other module of the subset of the cellular site field technician training modules or through the other subset of the cellular site field technician training modules.

7. The computer-implemented method of claim 1, further comprising locking other functionality of computing device or denying work opportunities until training is completed.

8. The computer-implemented method of claim 1, further comprising receiving a new training notification based on an update or addition to the subset of the cellular site field technician training modules or based on a change in responsibilities, technology, or environment associated with the trainee.

9. The computer-implemented method of claim 1, further comprising enabling the trainee to participate in training offered through additional training modules using the XR headset and reporting completion of the training offered through the additional training modules to a remote service.

10. A non-transitory computer-readable storage medium having a plurality of programming instructions stored thereon that, when executed by a computing device, cause the computing device to perform operations comprising:
receiving a request to identify a subset of a cellular site field technician training modules associated with at least one of a location, an environment type, a cellular site technology, or a minimum level or requirements;
responding with an identification of the subset of cellular site field technician training modules to a computing device associated with an extended reality (XR) headset;
receiving updated or additional cellular site field technician training modules; and
providing an updated identification of the subset of a cellular site field technician training modules to the computing device associated with the XR headset, the updated identification including identification of the updated or additional cellular site field technician training modules.

11. The non-transitory computer-readable storage medium of claim 10, wherein the providing is based on automatically identifying users or devices that requested cellular site field technician training modules fitting criteria that are applicable to the updated or additional cellular site field technician training modules.

12. The non-transitory computer-readable storage medium of claim 10, wherein the operations further comprise providing the subset of cellular site field technician training modules to the computing device associated with the XR headset.

13. The non-transitory computer-readable storage medium of claim 10, wherein the operations further comprise receiving from the computing device associated with the XR headset a result of participation of a trainee using the XR headset in training offered through at least one module of the subset of the cellular site field technician training modules.

14. The non-transitory computer-readable storage medium of claim 13, wherein the operations further comprise providing at least one additional module from the cellular site field technician training modules to the computing device based at least in part on the result of the participation of the trainee.

15. The non-transitory computer-readable storage medium of claim 14, wherein the providing the at least one additional module from the cellular site field technician training modules is further based on other results from real-world activities or other computer-based training.

16. The non-transitory computer-readable storage medium of claim 13, wherein the operations further comprise interfacing with other systems of an operator of a telecommunication network associated with the trainee to provide the result of the participation of the trainee to adjust jobs available to the trainee.

17. The non-transitory computer-readable storage medium of claim 10, wherein the operations further comprise receiving results of machine learning from the computing device and from other computing devices and adjusting the identification of the subset of the cellular site field technician training modules based on the results of the machine learning.

18. A system comprising:
an extended reality (XR) headset;
a processor; and
a plurality of programming instructions configured to be executed by the processor, either on the XR headset or on another computing device, to perform operations including;
receiving an identification of a subset of cellular site field technician training modules, the cellular site field technician training modules including modules associated with at least one of a location, an environment type, a cellular site technology, or a minimum level or requirements;
enabling a trainee using the XR headset to participate in training offered through at least one module of the subset of the cellular site field technician training modules;
reporting a result of the participation in the training offered through the at least one module of the subset of the cellular site field technician training modules; and
enabling the trainee to participate in training offered through another module of the subset of the cellular site field technician training modules or through another subset of the cellular site field technician training modules based on the result of the participation in the training offered through the at least one module of the subset of the cellular site field technician training modules.

19. The system of claim 18, wherein the operations further include requiring the trainee to complete a real-world activity or other computer-based training before enabling the trainee to participate in the training offered through the other module of the subset of the cellular site field technician training modules or through the other subset of the cellular site field technician training modules.

20. The system of claim 18, wherein the operations further include receiving a new training notification based on an update or addition to the subset of the cellular site field technician training modules or based on a change in responsibilities, technology, or environment associated with the trainee.
